(19) United States
(12) Patent Application Publication
(10) Pub. No.: US 2006/0057174 A1
(43) Pub. Date: Mar. 16, 2006

(54) Natural-non-toxic insect repellant

(76) Inventor: Michael Meyhoefer, Danbury, CT (US)

Correspondence Address: JENNIFER MEREDITH;MEREDITH & KEYHANI, PLLC, 330 MADISON AVE., 6TH FLOOR, NEW YORK, NY, 10017, US

(21) Appl. No.: 10/942,649

(22) Filed: Sep. 16, 2004

(51) Int. Cl. A01N 65/00

(52) U.S. Cl. 424/405; 424/745

(57) ABSTRACT

The present invention provides an insect repellant solution comprising between 0.3 and 0.7 percent by weight rosemary oil, between 0.05 and 0.3 percent by weight citronella oil and between 0.1 and 0.3 percent by weight table salt. There may also be between 0.07 and 0.7 percent by weight mint oil, between 0.07 and 0.7 percent by weight lemon grass oil, between 0.07 and 0.7 percent by weight thyme oil, between 0.07 and 0.7 percent by weight wintergreen oil and between 7 and 12 percent by weight vinegar.

### BACKGROUND OF THE INVENTION

The present invention relates generally to insect repellents and more specifically to mosquito, fly, tick and mite repellents using biologically based natural components.

Insects, such as mosquitoes, pose a serious health threat to humans. Insects are known to carry viral diseases including West Nile Virus, which when transferred to humans proves to be deadly. Other insects, even when not infected with a virus can cause humans a great amount of discomfort through their bites. Therefore, for both health and comfort reasons, it is important that mosquitoes, and other biting insects, be kept away from areas inhabited by humans.

Known insect repellents frequently contain harsh chemicals and can be seriously harmful if not used properly. Chemicals found in most common forms of insect repellent must be kept away from eyes, nose, mouth, open cuts, open flames, food and children, and must be washed off when no longer needed because of the unknown long term effects of use.

The majority of insect repellents currently on the market are made up of chemical compounds which could potentially be harmful over a prolonged period of time, especially to children and pets. The foremost active ingredient presently found in insect repellents is N,N,-diethyl-m-toluamide (DEET), and the current US Army insect repellent (EDTIAR) contains DEET as its active ingredient. The major commercial brands, Off™, “Deep Woods Off!™, and Cutter™, are all DEET based products and comprise 85% of insect repellent sales (Consumer Reports Buying Guide, 1994 Special Year-End Issue). Consumer Reports tests indicated that products with the highest concentration of DEET lasted the longest against mosquitoes, but cautioned that excessive use of DEET could pose some risk, especially for children. Other disadvantages associated with DEET include: It is a synthetic chemical having a limited spectrum of activity and a noticeably unpleasant odor; DEET is a powerful plasticizer and will dissolve or mar many plastics and painted surfaces; DEET plasticizes the inert ingredients typically used in topical formulations in order to lengthen the time of effectiveness. This leads to DEET formulations with low user acceptability.

In recent years, a proprietary bath oil (Skin-So-Soft™, Avon Products, Inc., New York) has been used as a topical insect repellent. Two of its ingredients (diisopropyl adipate and benzophenone) are repellent to Aedes aegypti (King, W. V. 1954. Chemicals evaluated as insecticides and repellents at Orlando, Fla. U.S. Dept. of Agriculture, Agriculture Handbook No. 69:1-397). However, the bath oil was reported as less effective and less persistent than DEET (Rutledge et al., 1982, Repellent activity of a proprietary bath oil (Skin-So-Soft), Mosquito News:42:557-559).

Efforts to develop a natural insect repellent have motivated studies of oils of citronella, turpentine, pennyroyal, cedarwood, eucalyptus and wintergreen, but studies have found these are relatively ineffective (Handbook of Nonprescription Drugs, 1993, 10th Ed., American Pharmaceutical Assn., Washington, D.C.). Consumer Reports tests indicated that “natural products” and products without DEET, including Skin-So-Soft.RTM., provided little or no protection against mosquitoes (Consumer Reports Buying Guide, 1994 Special Year-End Issue). Insect repellents for nonprescription oral use are not generally recognized as safe and effective (Federal Register, 1985, 50:25170).

While previous efforts have not been successful, the present invention provides lasting and effective repellants using the all natural ingredients.

### SUMMARY OF THE INVENTION

The present invention relates generally to natural pest repellants and more specifically to natural insect repellants.

According to one embodiment, an insect repellant solution is disclosed comprising rosemary oil, citronella oil and table salt.

According to another embodiment, an insect repellant is disclosed comprising between 0.3 and 0.7 percent by weight rosemary oil, between 0.05 and 0.3 percent by weight citronella oil and between 0.1 and 0.3 percent by weight table salt.

According to another embodiment, an insect repellant solution is disclosed comprising between 0.3 and 0.7 percent by weight rosemary oil, between 0.05 and 0.3 percent by weight citronella oil, between 0.1 and 0.3 percent by weight table salt, between 0.07 and 0.7 percent by weight mint oil, between 0.07 and 0.7 percent by weight lemon grass oil, between 0.07 and 0.7 percent by weight thyme oil, between 0.07 and 0.7 percent by weight wintergreen oil and between 7 and 12 percent by weight vinegar.

According to yet another embodiment, an insect repellent is disclosed comprising between 2 and 4 ounces rosemary oil, between 0.5 and 2.0 ounces citronella oil, between 2 and 4 tablespoons table salt, between 50 and 70 ounces vinegar, between 1 and 3 tablespoons guar gum and between 4 and 5 gallons of water.

According to yet another embodiment is disclosed comprising between 2 and 4 ounces rosemary oil, between 0.5 and 2.0 ounces citronella oil, between 2 and 4 tablespoons table salt, between 50 and 70 ounces vinegar, between 1 and 3 tablespoons guar gum, between 4 and 5 gallons of water, between 0.5 and 4.0 ounces mint oil, between 0.5 and 4.0 ounces lemon grass oil, between 0.5 and 4.0 ounces thyme oil and between 0.5 and 4.0 ounces wintergreen oil.

According to yet another embodiment, a method of manufacturing an insect repellent is disclosed comprising the steps of providing a five gallon container, placing between 2 and 4 ounces rosemary oil in the five gallon container, placing between 0.5 and 2.0 ounces citronella oil in the five gallon container, placing between 2 and 4 tablespoons table salt in the five gallon container and adding water sufficient to fill the five gallon container.

These and other features, aspects and advantages of the present invention will become better understood with reference to the description and claims.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

According to the present invention, an insect repellant solution is disclosed comprising rosemary oil, citronella oil and table salt. Rosemary oil may be between 0.3 and 0.7 percent by weight. The citronella oil may be between 0.05 and 0.3 percent by weight. The table salt may be between 0.1 and 0.3 percent by weight. Water may be in the solution between 60 and 99.4 percent by weight. There may also be mint oil, lemon grass oil, thyme oil, wintergreen oil. The mint oil may be between 0.07 and 0.7 percent by weight. Lemon grass oil may be between 0.07 and 0.7 percent by weight. Thyme oil may be between 0.07 and 0.7 percent by weight. Wintergreen oil may be between 0.07 and 0.7 percent by weight. Other additives may be lime juice, latex, xanthum gum, gum arabic and vinegar. The vinegar may be between 7 and 12 percent by weight.

### EXAMPLE 1

An insect repellant containing:
three ounces of rosemary oil;
one ounce of citronella oil;
three tablespoons of salt;
sixty ounces of vinegar;
two tablespoons of guar gum; and
water sufficient to make five gallons.

According to a preferred embodiment, a method of manufacturing the same insect repellant is disclosed; five gallons of the insect repellant is prepared by: mixing three (3) ounces of rosemary oil, one (1) ounce of citronella oil, and three (3) tablespoons of salt to provide a first mixture; adding 60 ounces of vinegar to the first mixture to provide a second mixture; adding water to the second mixture sufficient to make five gallons and adding two (2) tablespoons of guar gum to the third mixture to provide the insect repellant; and mixing the insect repellant for approximately three minutes.

The method of manufacturing may optionally further comprise any of the following steps: adding between 0.5 and 4.0 ounces mint oil to the second mixture before the step of adding water sufficient to make a third mixture; adding between 0.5 and 4.0 ounces lemon grass oil to the second mixture before the step of adding water sufficient to make a third mixture; adding between 0.5 and 4.0 ounces thyme oil to the second mixture before the step of adding water sufficient to make a third mixture; adding between 0.5 and 4.0 ounces wintergreen oil to the second mixture before the step of adding water sufficient to make a third mixture.

One specific insect repellant solution is disclosed comprising between 0.3 and 0.7 percent by weight rosemary oil, between 0.05 and 0.3 percent by weight citronella oil, between 0.1 and 0.3 percent by weight table salt, between 0.07 and 0.7 percent by weight mint oil, between 0.07 and 0.7 percent by weight lemon grass oil, between 0.07 and 0.7 percent by weight thyme oil, between 0.07 and 0.7 percent by weight wintergreen oil and between 7 and 12 percent by weight vinegar. There may also be an additive. The additive may be lime juice, latex, xanthum gum and/or gum arabic.

In a preferred embodiment, a 5 gallon solution of the insect repellent would comprise between 2 and 4 ounces rosemary oil, between 0.5 and 2.0 ounces citronella oil, between 2 and 4 tablespoons table salt, between 50 and 70 ounces vinegar, between 1 and 3 tablespoons guar gum and between 4 and 5 gallons of water. There may also between 0.5 and 4.0 ounces mint oil, between 0.5 and 4.0 ounces lemon grass oil, between 0.5 and 4.0 ounces thyme oil and between 0.5 and 4.0 ounces wintergreen oil. An additional additive may be added such as lime, latex, xantham gum and gum arabic.

Also disclosed is a method of manufacturing the above referenced insect repellants. The method of manufacturing an insect repellent, may comprise the steps of: providing a five gallon container; placing between 2 and 4 ounces rosemary oil in the five gallon container; placing between 0.5 and 2.0 ounces citronella oil in the five gallon container; placing between 2 and 4 tablespoons table salt in the five gallon container; and adding water sufficient to fill the five gallon container.

The method of manufacture may further comprise the step of adding additional ingredients prior to the step of adding water. This may include the step of placing between 50 and 70 ounces of vinegar in the five gallon container prior to the step of adding water sufficient to fill the five gallon container. The step of placing between 1 and 3 tablespoons guar gum in the five gallon container prior to the step of adding water sufficient to fill the five gallon container. The step of placing between 0.5 and 4.0 ounces mint oil in the five gallon container prior to the step of adding water sufficient to fill the five gallon container. The step of placing between 0.5 and 4.0 ounces lemon grass oil in the five gallon container prior to the step of adding water sufficient to fill the five gallon container. The step of placing between 0.5 and 4.0 ounces thyme oil in the five gallon container prior to the step of adding water sufficient to fill the five gallon container. The step of placing between 0.5 and 4.0 ounces wintergreen oil in the five gallon container prior to the step of adding water sufficient to fill the five gallon container.

It should be understood that the foregoing relates to preferred embodiments of the invention and that modifications may be made without departing from the spirit and scope of the invention as set forth in the following claims.

I claim:

1. An insect repellant solution comprising:
rosemary oil;
citronella oil; and
table salt.

2. An insect repellant solution as in claim 1, further comprising mint oil.

3. An insect repellant solution as in claim 1, further comprising lemon grass oil.

4. An insect repellant solution as in claim 1, further comprising thyme oil.

5. An insect repellant solution as in claim 1, further comprising wintergreen oil.

6. An insect repellant solution as in claim 1, further comprising lime juice.

7. An insect repellant solution as in claim 1, further comprising latex.

8. An insect repellant solution as in claim 1, further comprising xanthum gum.

9. An insect repellant solution as in claim 1, further comprising gum arabic.

10. An insect repellant solution as in claim 1, further comprising vinegar.

11. An insect repellant solution as in claim 1, further comprising water.

12. An insect repellant solution as in claim 1, wherein said rosemary oil is between 0.3 and 0.7 percent by weight.

13. An insect repellant solution as in claim 1, wherein said citronella oil is between 0.05 and 0.3 percent by weight.

14. An insect repellant solution as in claim 1, wherein said table salt is between 0.1 and 0.3 percent by weight.

15. An insect repellant solution as in claim 10, wherein said vinegar is between 7 and 12 percent by weight.

16. An insect repellent according to claim 11, wherein said water is between 60 and 99.4 percent by weight.

17. An insect repellant solution comprising:
between 0.3 and 0.7 percent by weight rosemary oil;
between 0.05 and 0.3 percent by weight citronella oil; and
between 0.1 and 0.3 percent by weight table salt.

18. An insect repellant solution as in claim 17, further comprising between 0.07 and 0.7 percent by weight mint oil.

19. An insect repellant solution as in claim 17, further comprising between 0.07 and 0.7 percent by weight lemon grass oil.

20. An insect repellant solution as in claim 17, further comprising between 0.07 and 0.7 percent by weight thyme oil.

21. An insect repellant solution as in claim 17, further comprising between 0.07 and 0.7 percent by weight wintergreen oil.

22. An insect repellant solution as in claim 17, further comprising lime juice.

23. An insect repellant solution as in claim 17, further comprising latex.

24. An insect repellant solution as in claim 17, further comprising xanthum gum.

25. An insect repellant solution as in claim 17, further comprising gum arabic.

26. An insect repellant solution as in claim 17, further comprising vinegar.

27. An insect repellant solution as in claim 26, wherein said vinegar is between 7 and 12 percent by weight.

28. An insect repellant solution comprising:
between 0.3 and 0.7 percent by weight rosemary oil;
between 0.05 and 0.3 percent by weight citronella oil;
between 0.1 and 0.3 percent by weight table salt;
between 0.07 and 0.7 percent by weight mint oil;
between 0.07 and 0.7 percent by weight lemon grass oil;
between 0.07 and 0.7 percent by weight thyme oil;
between 0.07 and 0.7 percent by weight wintergreen oil; and
between 7 and 12 percent by weight vinegar.

29. An insect repellant solution as in claim 28, further comprising an additive, said additive being selected from the group consisting of lime juice, latex, xanthum gum and gum arabic.

30. An insect repellent, said insect repellent comprising:
between 2 and 4 ounces rosemary oil;
between 0.5 and 2.0 ounces citronella oil;
between 2 and 4 tablespoons table salt;
between 50 and 70 ounces vinegar;
between 1 and 3 tablespoons guar gum; and
between 4 and 5 gallons of water.

31. An insect repellent as in claim 30, further comprising mint oil.

32. An insect repellent as in claim 30, further comprising lemon grass oil.

33. An insect repellent as in claim 30, further comprising thyme oil.

34. An insect repellent as in claim 30, further comprising wintergreen oil.

35. An insect repellent as in claim 30, further comprising lime juice.

36. An insect repellent as in claim 30, further comprising latex.

37. An insect repellent as in claim 30, further comprising xantham gum.

38. An insect repellent as in claim 30, further comprising gum arabic.

39. An insect repellent, said insect repellent comprising:
between 2 and 4 ounces rosemary oil;
between 0.5 and 2.0 ounces citronella oil;
between 2 and 4 tablespoons table salt;
between 50 and 70 ounces vinegar;
between 1 and 3 tablespoons guar gum;
between 4 and 5 gallons of water;
between 0.5 and 4.0 ounces mint oil;
between 0.5 and 4.0 ounces lemon grass oil;
between 0.5 and 4.0 ounces thyme oil; and
between 0.5 and 4.0 ounces wintergreen oil.

40. An insect repellent as in claim 39, further comprising lime juice.

41. An insect repellent as in claim 39, further comprising latex.

42. An insect repellent as in claim 39, further comprising xantham gum.

43. An insect repellent as in claim 39, further comprising gum arabic.

44. A method of manufacturing an insect repellent, said method comprising the steps of:
providing a five gallon container;
placing between 2 and 4 ounces rosemary oil in said five gallon container;
placing between 0.5 and 2.0 ounces citronella oil in said five gallon container;
placing between 2 and 4 tablespoons table salt in said five gallon container; and
adding water sufficient to fill said five gallon container.

45. A method of manufacture as in claim 44, further comprising the step of:
placing between 50 and 70 ounces of vinegar in said five gallon container prior to said step of adding water sufficient to fill said five gallon container.

46. A method of manufacture as in claim 44, further comprising the step of:
placing between 1 and 3 tablespoons guar gum in said five gallon container prior to said step of adding water sufficient to fill said five gallon container.

47. A method of manufacture as in claim 44, further comprising the step of:
placing between 0.5 and 4.0 ounces mint oil in said five gallon container prior to said step of adding water sufficient to fill said five gallon container.

48. A method of manufacture as in claim 44, further comprising the step of:
placing between 0.5 and 4.0 ounces lemon grass oil in said five gallon container prior to said step of adding water sufficient to fill said five gallon container.

49. A method of manufacture as in claim 44, further comprising the step of:
placing between 0.5 and 4.0 ounces thyme oil in said five gallon container prior to said step of adding water sufficient to fill said five gallon container.

50. A method of manufacture as in claim 44, further comprising the step of:
placing between 0.5 and 4.0 ounces wintergreen oil in said five gallon container prior to said step of adding water sufficient to fill said five gallon container.

51. A method of manufacturing an insect repellant, said method comprising the steps of:
mixing three ounces of rosemary oil, one ounce citronella oil and three table spoons of salt to provide a first mixture;
adding sixty ounces of vinegar to said first mixture to provide a second mixture;
adding water to said second mixture sufficient to make a third mixture that is five gallons;
adding two tablespoons of guar gum to said third mixture to provide said insect repellant; and
mixing said insect repellant for approximately three minutes.

52. A method of manufacturing an insect repellant as in claim 51, further comprising the step of:
adding between 0.5 and 4.0 ounces mint oil to said second mixture before said step of adding water sufficient to make a third mixture.

53. A method of manufacturing an insect repellant as in claim 51, further comprising the step of:
adding between 0.5 and 4.0 ounces lemon grass oil to said second mixture before said step of adding water sufficient to make a third mixture.

54. A method of manufacturing an insect repellant as in claim 51, further comprising the step of:
adding between 0.5 and 4.0 ounces thyme oil to said second mixture before said step of adding water sufficient to make a third mixture.

55. A method of manufacturing an insect repellant as in claim 51, further comprising the step of:
adding between 0.5 and 4.0 ounces wintergreen oil to said second mixture before said step of adding water sufficient to make a third mixture.
